(19) United States
(12) Patent Application Publication
(10) Pub. No.: US 2026/0339310 A1
(43) Pub. Date: Oct. 29, 2026

(54) ANOMALY DETECTION BASED ON MACHINE LEARNING

(71) Applicant: Walmart Apollo, LLC, Bentonville, AR (US)

(72) Inventors: Hanzhang Wang, Santa Clara, CA (US); Ramesh Babu Mandava, Fremont, CA (US); Gowtham Kumar Tangirala, Cranberry Township, PA (US); Gilkara Pranav Naidu, Etobicoke (CA); Charles David Mayville, Redwood City, CA (US); Hongyu Sun, San Francisco, CA (US)

(21) Appl. No.: 19/187,758

(22) Filed: Apr. 23, 2025

Related U.S. Application Data
(60) Provisional application No. 63/638,115, filed on Apr. 24, 2024.

(51) Int. Cl. G05B 23/02; G05B 13/02

(52) U.S. Cl. CPC G05B 23/0259; G05B 13/0265

(57) ABSTRACT

Examples may be related to detecting anomalies based on machine learning. An example may involve: receiving a set of inputs via a first interface; generating a set of machine learning models in response to the set of inputs; deploying the set of machine learning models to detect an anomaly; receiving feedback indicating a drift of at least one machine learning model in the set of machine learning models; and re-training the at least one machine learning model to correct the drift.

### CROSS-REFERENCE TO RELATED APPLICATION

This application claims benefit to U.S. Provisional Application No. 63/638,115, entitled “Systems and Methods for Anomaly Detection for Incident Response at Scale,” filed on Apr. 24, 2024, the disclosure of which is incorporated herein by reference in its entirety.

### BACKGROUND

In a complex system, e.g. a system of a large company or organization, it is to crucial to track system health metrics in real-time to ensure smooth day-to-day operations. Any single failure can potentially trigger a domino effect and impact multiple dependent systems, cascading into a major incident. Therefore, it is imperative to detect and mitigate any such issue as soon as possible, e.g. through an anomaly detection in real-time.

### BRID DESCRIPTION OF THE DRAWINGS

Various examples will be described by the following detailed description of the example embodiments, which is to be considered together with the accompanying drawings wherein like numbers refer to like parts and further wherein:

FIG. 1 depicts an example system for detecting anomalies based on machine learning, in accordance with some embodiments;

FIG. 2 depicts an example computer system that implements one or more of the disclosed processes, in accordance with some embodiments;

FIG. 3 illustrates an example architecture of an anomaly detection system, in accordance with some embodiments;

FIG. 4 illustrates an example user interface for model onboarding of an anomaly detection system, in accordance with some embodiments;

FIG. 5 shows a flowchart illustrating an example method for detecting anomalies based on machine learning, in accordance with some embodiments;

FIG. 6 shows a flowchart illustrating an example method for mitigating a detected anomaly, in accordance with some embodiments;

FIG. 7 shows a flowchart illustrating an example method for re-training at least one machine learning model, in accordance with some embodiments;

FIG. 8 shows a flowchart illustrating an example method for receiving a set of inputs, in accordance with some embodiments;

FIG. 9 shows a flowchart illustrating another example method for receiving a set of inputs, in accordance with some embodiments;

FIG. 10 shows a flowchart illustrating an example method for generating a set of machine learning models, in accordance with some embodiments;

FIG. 11 shows a flowchart illustrating an example method for training a machine learning model, in accordance with some embodiments;

FIG. 12 shows a flowchart illustrating an example method for deploying a set of machine learning models, in accordance with some embodiments; and

FIG. 13 depicts an example system with a machine-readable medium that includes instructions for detecting anomalies based on machine learning, in accordance with some embodiments.

### DETAILED DESCRIPTION

In some embodiments, systems and methods are described herein for detecting anomalies based on machine learning. For example, one or more machine learning models may be deployed to detect anomalies associated with various applications in a system.

In some examples, a machine learning based anomaly detection can replace or enhance a rule-based anomaly alerting and monitoring, which would be time consuming, incomplete in coverage, and agnostic to interdependent data patterns. In order to achieve high recall, rule-based alerting systems often increase alert volume in order to increase coverage, resulting in very low precision, which would cause alert fatigue and reduce the efficacy.

In various embodiments, a machine learning-based anomaly detection system and methods are disclosed. In some embodiments, the machine-learning based anomaly detection system may be referred to as “AI Detect and Respond (AIDR).” AIDR is configured to monitor network system health in real-time. The disclosed systems and methods leverage statistical, machine learning, and deep learning models while continuing to incorporate rule-based static thresholds to incorporate domain-specific knowledge. In various embodiments, both univariate and multivariate machine learning models may be deployed and maintained through distributed services for scalability and high availability. AIDR may provide a feedback loop that assesses model quality, for example, with a combination of drift detection algorithms and customer feedback. AIDR may further offer self-onboarding capabilities and customizability. AIDR can provide lower time to detection and fewer false positives than previous methods.

In some embodiments, a disclosed system has user-friendly interfaces built and provided to offer a high degree of customizability for building anomaly detection models while minimizing required machine learning knowledge, which also enables engineers and customers to integrate their domain-specific knowledge and constraints when configuring alerts.

In some examples, the disclosed system operates on a cloud infrastructure, to deliver a practical, scalable, self-service machine learning-based alert system that is capable of delivering accurate, smart, and adaptable alerts to any user as needed. The system can scale efficiently and eliminate the necessity for any ad-hoc scripting.

In addition, the system may include a self-healing model monitoring running machine learning models with automatic drift detection and feedback monitoring features. This may remove or significantly reduce the need for manual intervention to maintain the model life-cycle, thereby rendering the system fully automatic, resulting in a reliable model life-cycle management.

In various embodiments, a system including a processor and a non-transitory memory storing instructions is disclosed. The instructions, when executed, cause the processor to: receive a set of inputs via a first interface; generate a set of machine learning models in response to the set of inputs; deploy the set of machine learning models to detect an anomaly; receive feedback indicating a drift of at least one machine learning model in the set of machine learning models; and re-train the at least one machine learning model to correct the drift.

In various embodiments, a computer-implemented method is disclosed. The computer-implemented method includes: receiving a set of inputs via a first interface; generating a set of machine learning models in response to the set of inputs; deploying the set of machine learning models to detect an anomaly; receiving feedback indicating a drift of at least one machine learning model in the set of machine learning models; and re-training the at least one machine learning model to correct the drift.

In various embodiments, a non-transitory computer readable medium having instructions stored thereon is disclosed. The instructions, when executed by at least one processor, cause at least one device to perform operations including: receiving a set of inputs via a first interface; generating a set of machine learning models in response to the set of inputs; deploying the set of machine learning models to detect an anomaly; receiving feedback indicating a drift of at least one machine learning model in the set of machine learning models; and re-training the at least one machine learning model to correct the drift.

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that enables the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

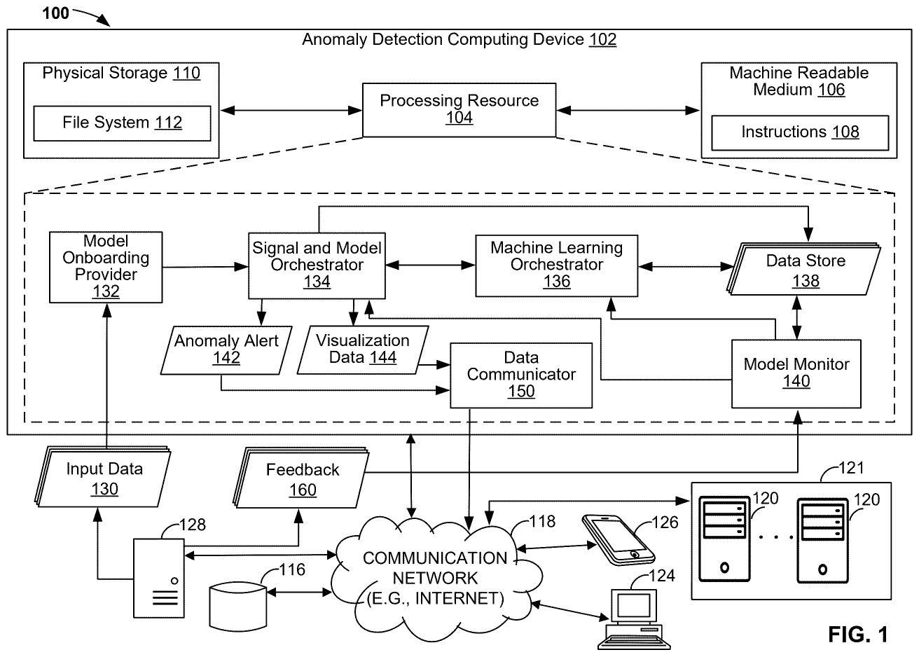

Turning to the drawings, FIG. 1 depicts an example system 100 for detecting anomalies based on machine learning, in accordance with some embodiments. The system 100 in this example includes an anomaly detection computing device 102 that detects anomalies of one or more applications based on input data 130 associated with the one or more applications.

In some embodiments, the anomaly detection computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The anomaly detection computing device 102 can also include a non-transitory machine readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine readable medium 106 to perform functions of the anomaly detection computing device 102, such as receiving a set of inputs via a first interface, generate a set of machine learning models in response to the set of inputs, deploy the set of machine learning models to detect an anomaly, etc. The instructions 108 may include instructions for implementing one or more models. In some embodiments, and as will be described further herein below, the anomaly detection computing device 102 may execute one or more models, processes, or algorithms, such as a machine learning model, deep learning model, statistical model, etc., (e.g., as implemented as machine readable instructions) to detect anomalies.

The anomaly detection computing device 102 may also include other hardware components, such as physical storage 110. The physical storage 110 may include any physical storage device, such as a hard disk drive, a solid state drive, or the like, or a plurality of such storage devices (e.g., an array of disks), and may be locally attached (i.e., installed) in the anomaly detection computing device 102. In some implementations, the physical storage 110 may be accessed as a block storage device.

In some cases, the anomaly detection computing device 102 may also include a local file system 112 that may be implemented as a layer on top of the physical storage 110. For example, an operating system 112 may be executing on the anomaly detection computing device 102 (by virtue of the processing resource 104 executing certain instructions 108 related to the operating system) and the operating system 112 may provide a file system 112 to store data on the physical storage 110.

As shown in FIG. 1, the anomaly detection computing device 102 may communicate with a plurality of devices or systems over one or more network channels, illustrated as a network cloud 118. For example, in various embodiments, the anomaly detection computing device 102 may be in communication with a server 128 (e.g., a web server or an application server), a cloud-based engine 121 including one or more processing devices 120 that may be provisioned for use, a database 116, a workstation 124, and/or any other suitable system or device. The anomaly detection computing device 102 may similarly be in communication, either directly or indirectly, with one or more user computing devices 126 operatively coupled over the network 118. The other computing systems may be similar to the anomaly detection computing device 102, and may each include at least a processing resource and a machine readable medium.

In some examples, each of the anomaly detection computing device 102 and the processing devices 120 can be a computer, a workstation, a laptop, a server such as a cloud-based server, or any other suitable device. In some examples, each of the processing devices 120 is a server that includes one or more processing units, such as one or more graphical processing units (GPUs), one or more Tensor Processing U nits (TPU s), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the anomaly detection computing device 102.

In some examples, each of the one or more user computing devices 126 can be a cellular phone, a smart phone, a tablet, a personal assistant device, a voice assistant device, a digital assistant, a laptop, a computer, a laser-based code scanner, or any other suitable device. In some examples, the server 128 hosts one or more websites or apps providing one or more products or services. In some examples, the anomaly detection computing device 102, the processing devices 120, and/or the server 128 are operated by a corporation, e.g. a big retailer, and the one or more user computing devices 126 are operated by customers, advertisers, engineers, associates or managers of the corporation. In some examples, the processing devices 120 are operated by a third party (e.g., a cloud-computing provider).

The workstation 124 may be operably coupled to the communication network 118 and can communicate with the anomaly detection computing device 102 over the communication network 118. In some examples, the workstation 124 may be located at a fulfillment node of a retailer, e.g. a store, a warehouse, a fulfillment center or a distribution center of the retailer.

Although FIG. 1 illustrates one user computing device 126, the system 100 can include any number of user computing devices 126. Similarly, the system 100 can include any number of the anomaly detection computing devices 102, the processing devices 120, the workstations 124, the servers 128, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, the anomaly detection computing device 102 is further operable to communicate with the database 116 over the communication network 118. For example, the anomaly detection computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the anomaly detection computing device 102, in some examples, the database 116 can be a local storage device, such as a hard drive, a non-volatile memory, or a USB stick.

In some embodiments, the server 128 may send the input data 130 to the anomaly detection computing device 102. In some examples, the input data 130 is sent together with an anomaly detection request, which may be initiated by an engineer of a system or application being monitored. In some examples, the input data 130 is sent automatically at predetermined times to the anomaly detection computing device 102, e.g. every minute, every hour, every day, etc.

In response to receiving the input data 130, the anomaly detection computing device 102 may execute one or more processes to generate a set of machine learning models, deploy the set of machine learning models to detect an anomaly associated with a corresponding application, and generate an anomaly alert 142 upon a detection of the anomaly. In some embodiments, the anomaly detection computing device 102 may receive feedback 160 indicating a drift of at least one machine learning model in the set of machine learning models; and re-train the at least one machine learning model to correct the drift. In various embodiments, the feedback 160 may be sent to the anomaly detection computing device 102 from the server 128, an engineer via one of the user computing devices 126, or a manager via the workstation 124. In various embodiments, the anomaly detection computing device 102 may provide a visualization of one or more model-related signals and/or detected anomaly for presentation at one or more of the server 128, the workstation 124 and the user computing devices 126.

As shown in FIG. 1, the processing resource 104 may include various components for anomaly detection. For example, the processing resource 104 may include a model onboarding provider 132, a signal and model orchestrator 134, a machine learning orchestrator 136, a model monitor 140 and a data communicator 150.

In some examples, the model onboarding provider 132 can receive the input data 130 for generating a set of machine learning models. In some examples, the input data 130 includes a set of inputs received via a first interface. In some embodiments, the set of inputs may be received based at least in part by: providing, via the first interface to a first user, a visualization of one or more model-related signals each with a default configuration; and receiving the set of inputs from the first user for generating the set of machine learning models based on the visualization. For example, the signal and model orchestrator 134 may provide visualization data 144 including the visualization of one or more model-related signals each with a default configuration to an engineer via the first interface. The engineer may send the set of inputs based on the visualized signals to generate the set of machine learning models.

In some embodiments, the set of inputs is received based at least in part by: selecting one or more model-related signals each with a configuration customized based on a specific requirement of a second user; generating a plurality of candidate machine learning models for an initial validation based on the one or more model-related signals; and receiving the set of inputs from the second user for generating the set of machine learning models based on the plurality of candidate machine learning models. For example, based on a bulk onboarding requirement of a manager, the signal and model orchestrator 134 may select one or more model-related signals each with a configuration meeting the bulk onboarding requirement. The signal and model orchestrator 134 may quickly build, by itself or in cooperation with the machine learning orchestrator 136, one or more models for an initial validation based on the one or more model-related signals and provide the validated models to the manager. The manager may send the set of inputs based on the validated models to generate or train the entire set of machine learning models.

In some embodiments, the model onboarding provider 132 can generate onboarding signals based on the input data 130 and send the onboarding signals to the signal and model orchestrator 134. In some examples, the signal and model orchestrator 134 collects the onboarding signals from the model onboarding provider 132. Based on the onboarding signals, the signal and model orchestrator 134 may work with the machine learning orchestrator 136 to generate the set of machine learning models and/or deploy the set of machine learning models to detect anomalies.

In some embodiments, each machine learning model in the set of machine learning models may be generated based at least in part by: retrieving historical data and configuration data from a model database based on the set of inputs; generating a signal dataset based on the historical data and the configuration data; generating a temporary version of the machine learning model based on a subset of the signal dataset; providing, via the first interface to a user, a preview of an anomaly detection performance of the temporary version of the machine learning model; and training the machine learning model based on the signal dataset in accordance with a determination that the user is satisfied with the preview of the anomaly detection performance. For example, the signal and model orchestrator 134 may generate a model training request based on the onboarding signals collected from the model onboarding provider 132, and send the model training request to the machine learning orchestrator 136 for training the set of machine learning models. For each machine learning model, the machine learning orchestrator 136 may retrieve historical data and configuration data from a model database, which may be part of a data store 138 or a standalone database, based on the model training request, and generate a signal dataset based on the historical data and the configuration data. Based on a subset of the signal dataset, the machine learning orchestrator 136 can generate a temporary version of the machine learning model, and provide a preview of an anomaly detection performance of the temporary version of the machine learning model, e.g. as part of the visualization data 144 to a user. In accordance with a determination that the user is satisfied with the preview of the anomaly detection performance, the machine learning orchestrator 136 may train the machine learning model based on the signal dataset.

In some examples, training the machine learning model may comprise: processing the historical data and the configuration data in the signal dataset; selecting a model type from a plurality of model types based on the set of inputs; training one or more hyperparameters of the machine learning model based on the signal dataset according to the model type; performing one or more model enrichments on the machine learning model; generating model metadata for the machine learning model, wherein the model metadata includes insight data representing at least one cause for a given anomaly; and registering the machine learning model with the model metadata in a model registry database. For example, the machine learning orchestrator 136 may process the historical data and the configuration data in the signal dataset, and select a model type from a plurality of model types (e.g. Auto-Regressive Integrated Moving Average (ARIMA), XGBoost, Isolation Forest (IF), Variational Autoencoder models, etc.) based on the model training request. The machine learning orchestrator 136 can train one or more hyperparameters of the machine learning model based on the signal dataset according to the model type. In some embodiments, the machine learning orchestrator 136 can also perform one or more model enrichments on the machine learning model, and generate model metadata for the machine learning model. In some examples, the model metadata may include insight data representing at least one cause for a given anomaly if it is detected based on the machine learning model. The machine learning model may be registered with the model metadata (e.g. signals used by the model, hyperparameters of the model, a current status, on or off, of the model, etc.) in a model registry database, which may be part of the data store 138 or a standalone database.

The signal and model orchestrator 134 and the machine learning orchestrator 136 in some examples can deploy the set of machine learning models to detect an anomaly. In some embodiments, the set of machine learning models may be deployed based at least in part by: periodically generating a model inference request; retrieving the set of machine learning models from the model registry database based on the model inference request; retrieving a plurality of anomaly metrics for the set of machine learning models from a metric database based on the model inference request; inserting the set of machine learning models and the plurality of anomaly metrics into a distributed model cache; generating predicted signals based on the set of machine learning models in the distributed model cache; determining prediction scores based on the predicted signals and actual signals corresponding to the predicted signals; detecting the anomaly based on the prediction scores and the plurality of anomaly metrics; and providing, via the first interface, a visualization of the actual signals, the predicted signals and the anomaly.

For example, the signal and model orchestrator 134 can periodically generate a model inference request, e.g. once every minute, every hour, every day, etc., and send the model inference request to the machine learning orchestrator 136. Based on the model inference request, the machine learning orchestrator 136 can retrieve the set of machine learning models from the model registry database, which may be part of the data store 138 or a standalone database. In addition, the machine learning orchestrator 136 can retrieve a plurality of anomaly metrics for the set of machine learning models from a metric database, which may be part of the data store 138 or a standalone database, based on the model inference request, and insert the set of machine learning models and the plurality of anomaly metrics into a distributed model cache, which may be part of the machine learning orchestrator 136 or part of the cloud-based engine 121. One or more predicted signals may be generated based on the set of machine learning models in the distributed model cache. Based on the predicted signals and actual signals corresponding to the predicted signals, the machine learning orchestrator 136 can determine prediction scores and detect the anomaly based on the prediction scores and the plurality of anomaly metrics, e.g. by comparing the prediction scores with corresponding thresholds related to the anomaly metrics. In some embodiments, the signal and model orchestrator 134 may provide a visualization of the actual signals, the predicted signals and the anomaly, e.g. in the visualization data 144 via the data communicator 150 to the user.

In some embodiments, upon a detection of the anomaly associated with a corresponding application, the signal and model orchestrator 134 may generate the anomaly alert 142, and send the anomaly alert 142 to the data communicator 150, which can send a message carrying the anomaly alert to a user of the corresponding application. In some embodiments, upon the detection of the anomaly, the signal and model orchestrator 134 and/or the machine learning orchestrator 136 may determine at least one system health metric degraded by the anomaly, and automatically perform one or more remediation actions in real time to mitigate the anomaly regarding the at least one system health metric.

The model monitor 140 in some examples can monitor the set of machine learning models registered in the data store 138 and may detect a drift of at least one machine learning model in the set of machine learning models, e.g. based on a feedback 160 received from the server 128. Upon a detection of the drift indicating a performance deviation of the at least one machine learning model compared to an expected baseline performance, the model monitor 140 may request the machine learning orchestrator 136 to re-train the at least one machine learning model to correct the drift.

In some embodiments, the at least one machine learning model is re-trained based at least in part by: verifying the drift based on: (1) a deviation of a statistical distribution of signal data compared to training data of the at least one machine learning model, and (2) a frequency of anomaly detection by the at least one machine learning model; and automatically re-training the at least one machine learning model by refining at least one hyperparameter of the at least one machine learning model based on the feedback and the verification of the drift. In some examples, the signal and model orchestrator 134 may provide a first visualization of the at least one machine learning model before re-training the at least one machine learning model, and provide a second visualization of the at least one machine learning model after re-training the at least one machine learning model, e.g. in the visualization data 144 via the data communicator 150 to the user.

The data communicator 150 in some examples receives the visualization data 144 from the signal and model orchestrator 134 and transmits the visualization data 144 to one or more computing devices via the network cloud 118. For example, the visualization data 144 can be transmitted to and presented via a user interface at the server 128, the workstation 124, the one or more user computing devices 126, etc. In some examples, the data communicator 150 may receive the anomaly alert 142 and transmit the anomaly alert 142, e.g. as a message, to one or more computing devices via the network cloud 118. For example, the anomaly alert 142 can be transmitted to the server 128, the workstation 124, the one or more user computing devices 126, etc. In some examples, a device receiving the anomaly alert 142 is different from a device receiving the visualization data 144. In some examples, the user interface showing the anomaly alert 142 is different from a user interface showing the visualization data 144.

In some examples, the anomaly detection computing device 102 generates and/or updates different models (e.g., machine learning models, deep learning models, statistical models, algorithms, natural language models, etc.) for detecting anomalies based on machine learning. The anomaly detection computing device 102 may generate training data for the models based on data including but not limited to: historical input data, historical application features, system health metrics, historical prediction scores, historical and/or labelled anomaly detection data, and historical user feedback data. The anomaly detection computing device 102 trains the models based on their corresponding training data, and stores the models in a database, such as in the database 116 (e.g., a cloud storage). The models, when executed by the anomaly detection computing device 102, enable the anomaly detection computing device 102 to detect and mitigate anomalies accordingly.

In some examples, the anomaly detection computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the anomaly detection computing device 102 may perform anomaly detection and mitigation automatically.

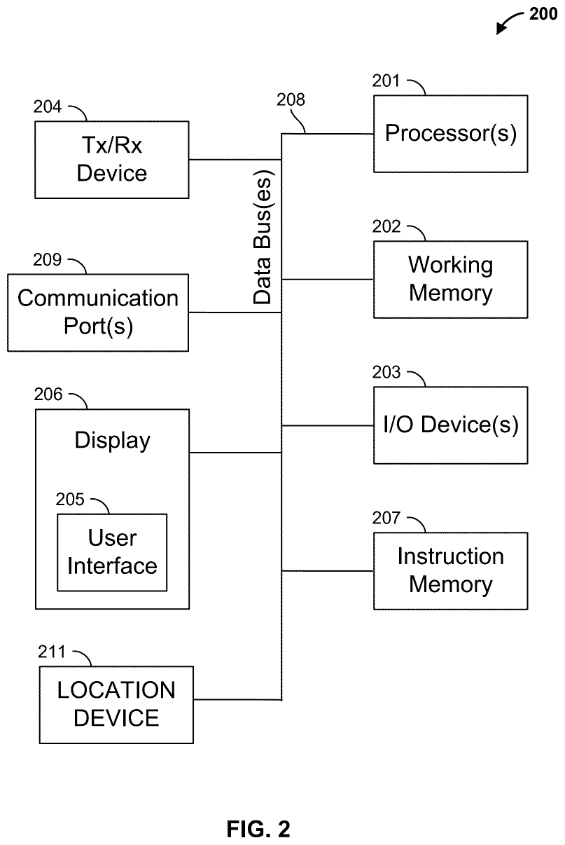

FIG. 2 illustrates a block diagram of a computing device 200, in accordance with some embodiments. In some embodiments, each of the anomaly detection computing device 102, the server 128, the workstation 124, the one or more user computing devices 126, and the one or more processing devices 120 in FIG. 1 may include the features shown in FIG. 2. Although FIG. 2 is described with respect to certain components shown therein, it will be appreciated that the elements of the computing device 200 can be combined, omitted, and/or replicated. In addition, it will be appreciated that additional elements other than those illustrated in FIG. 2 can be added to the computing device 200.

As shown in FIG. 2, the computing device 200 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 enable communication among the various components. The data buses 208 can include wired, or wireless, communication channels.

The one or more processors 201 can include any processing circuitry operable to control operations of the computing device 200. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 can implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NA ND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can perform a certain function or operation by executing code, stored on the instruction memory 207, embodying the function or operation. For example, the one or more processors 201 can execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the computing device 200 can include a single memory unit to operate as both instruction memory and working memory. Further, although embodiments are discussed herein including non-volatile memory, it will be appreciated that the computing device 200 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments, a compiler or interpreter can convert the instruction set into machine executable code for execution by the one or more processors 201.

The input-output devices 203 can include any suitable device that enables data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 enable communication with a network. For example, if a communication network is a cellular network, the transceiver 204 enables communications with the cellular network. In some embodiments, the transceiver 204 is selected based on the type of the communication network 118 the computing device 200 will be operating in. The one or more processors 201 are operable to receive data from, or send data to, a network, via the transceiver 204.

The communication port(s) 209 may include any suitable hardware, software, and/or combination of hardware and software that is capable of coupling the computing device 200 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 enables the programming of executable instructions in the instruction memory 207. In some embodiments, the communication port(s) 209 enables the transfer (e.g., uploading or downloading) of data, such as machine learning model training data.

In some embodiments, the communication port(s) 209 may couple the computing device 200 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 can utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PA N) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the computing device 200 and/or the server 128. For example, the user interface 205 can be a user interface for an application of a network environment operator that enables a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OL ED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device that receives position data identifying a latitude and longitude from one or more satellites of a GPS constellation. As another example, in some embodiments, the location device 211 is a cellular device that receives location data from one or more localized cellular towers. Based on the position data, the computing device 200 may determine a local geographical area (e.g., town, city, state, etc.) of its position.

In some embodiments, the computing device 200 can implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

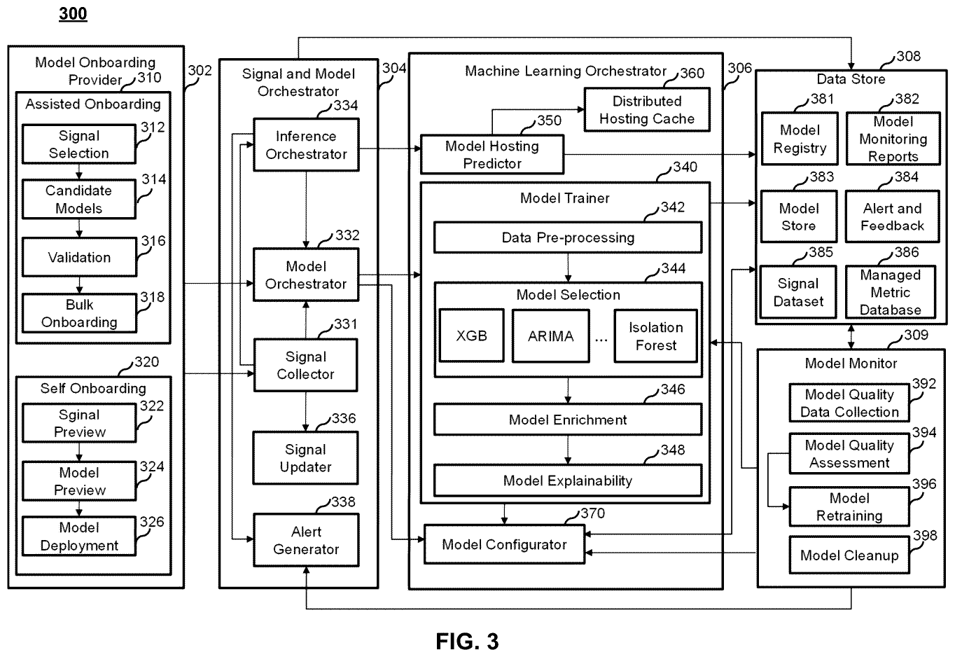

FIG. 3 illustrates an example architecture of an anomaly detection system 300, in accordance with some embodiments. In some embodiments, the anomaly detection system 300 may be implemented by the anomaly detection computing device 102 in FIG. 1. As shown in FIG. 3, the anomaly detection system 300 may include the following subsystems: a model onboarding provider 302, a signal and model orchestrator (SMO) 304, a machine learning orchestrator (MLO) 306, a data store 308 and a model monitor 309. In some embodiments, the model onboarding provider 302, the SMO 304, the MLO 306, the data store 308 and the model monitor 309 may be implemented by the model onboarding provider 132, the signal and model orchestrator 134, the machine learning orchestrator 136, the data store 138 and the model monitor 140 in FIG. 1, respectively.

In some embodiments, the SMO 304 may provide one or more application programming interfaces (APIs) to an onboarding user interface (UI), via the model onboarding provider 302, enabling registration of signals and training, registering, and deployment of models, etc. In some embodiments, the SMO 304 dispatches model training, model preview and model management requests to relevant components in the MLO 306. The SMO 304 may scan a model registry 381 in the data store 308 at a predetermined interval and/or continuously and may fetch real-time metrics from a managed metric database (MMD) 386 in the data store 308 for each model's signals. The SMO 304 may further call a model hosting predictor 350 in the MLO 306 to trigger predictions. The prediction scores and anomaly metrics may be published back to the MMD 386 where they may be read by interfaces and/or tools. In some embodiments, the SMO 304 also sends anomaly alerts as interactive messages to one or more messaging platforms, enabling feedback for individual alerts (e.g., true or false positives), and may store that feedback data for future model retraining.

In some embodiments, the model monitor 309 can empower a machine-learning life-cycle. The model monitor 309 may detect potential data drift by taking into account several statistical measures, for example, via a daily job. After identifying one or more models responsible for one or more errors or alerts, the model monitor 309 may generate one or more notifications with a preview of suggested improvements to the model. If consent for the changes is received, the disclosed systems and methods can seamlessly update the model, which may be utilized for real-time predictions immediately. The disclosed system also enables preservation of prediction quality and removes or minimizes manual intervention during a model's life-cycle.

As shown in FIG. 3, the model monitor 309 may perform a model quality data collection job 392, a model quality assessment job 394, a model retraining job 396, and a model cleanup job 398. Each of these jobs may be performed regularly at predetermined times (e.g. hourly, daily, etc.) or upon a triggering event. The model quality data collection job 392 can be performed to monitor quality of data related to a model. The model quality assessment job 394 can be performed to monitor quality of a model itself. The system may send an alert or notification to a user based on the monitoring results of the model quality data collection job 392 and the model quality assessment job 394, e.g. for maintenance purposes.

In some examples, when an active signal suddenly becomes flat, the model quality data collection job 392 may determine whether this signal has any issue or not, before sending a notification to a user. If the signal is wrong and should be deleted, the model quality data collection job 392 may call the model cleanup job 398 to delete the signal and update the model registry 381.

In some examples, when a signal of a model is detected to change out of a normal pattern, the model quality assessment job 394 can determine whether the model itself needs to be updated or not. For example, a signal changing its pattern may be due to an event, rather than an anomaly. As such, the model needs to be updated or re-trained, rather than sending an anomaly alert to a user. When the event is temporary like a promotion or a seasonal event, the model quality assessment job 394 may request an update of the model, e.g. updating a corresponding threshold for detecting an anomaly. When the event is permanent or a long-term event, the model quality assessment job 394 may request the model retraining job 396 to re-train the model.

In some examples, a drift of a model may be determined by the model quality assessment job 394, which can trigger the model retraining job 396 to determine whether to re-train the model or not. For example, if the detected drift is larger than a predetermined threshold or meets a predetermined condition, the model retraining job 396 may send a request to a model trainer 340 in the MLO 306 to re-train the model.

In some examples, the model cleanup job 398 can clean up or delete a model that is determined to be outdated, have an unfixable issue, or inactive for a long time, etc. The model cleanup job 398 may update the model registry 381 accordingly after cleaning up one or more models, e.g. by working in cooperation with a model configurator 370 in the MLO 306.

In some embodiments, the data store 308 is responsible for storing machine learning artifacts such as signal data in a signal dataset 385, serialized models in a model store 383, the model registry 381, alert and feedback data 384, model monitoring reports 382, as well as the MMD 386, all in a secure and organized manner. The SMO 304, the MLO 306, the model monitor 309, and/or the data store 308 may work in tandem to ensure that the disclosed system is learning and improving over time. The disclosed systems and methods can provide accurate and up-to-date predictions.

In some embodiments, a bespoke bulk onboarding strategy may be applied to onboard one or more users to the disclosed systems and methods. In some examples, an assisted onboarding flow 310 is shown in FIG. 3, illustrating the bulk onboarding strategy. At step 312, a signal selection is performed such that best signals may be selected for a specific use case. At step 314, one or more proof-of-concept (PoC) models may be generated as candidate models based on the selected signals. The candidate models may go through an initial validation at step 316. After the candidate models are validated, the system can perform bulk onboarding at step 318 for concurrently training and deploying additional models (e.g., hundreds or thousands of models). In some embodiments, each of these steps may be executed by leveraging the API interface offered by the SMO 304 via the model onboarding provider 302.

In some embodiments, a self-onboarding UI portal may be generated to enable visualizations of signals and training, previewing, adjusting, and deployment of anomaly detection models. In some examples, a self-onboarding flow 320 is shown in FIG. 3, illustrating a self-onboarding strategy. At step 322, a signal preview is performed to enable a user to preview signals. At step 324, a model preview is performed to enable the user to preview one or more models for onboarding. Upon one or more user inputs, a model deployment is performed at step 326 for one or more selected models.

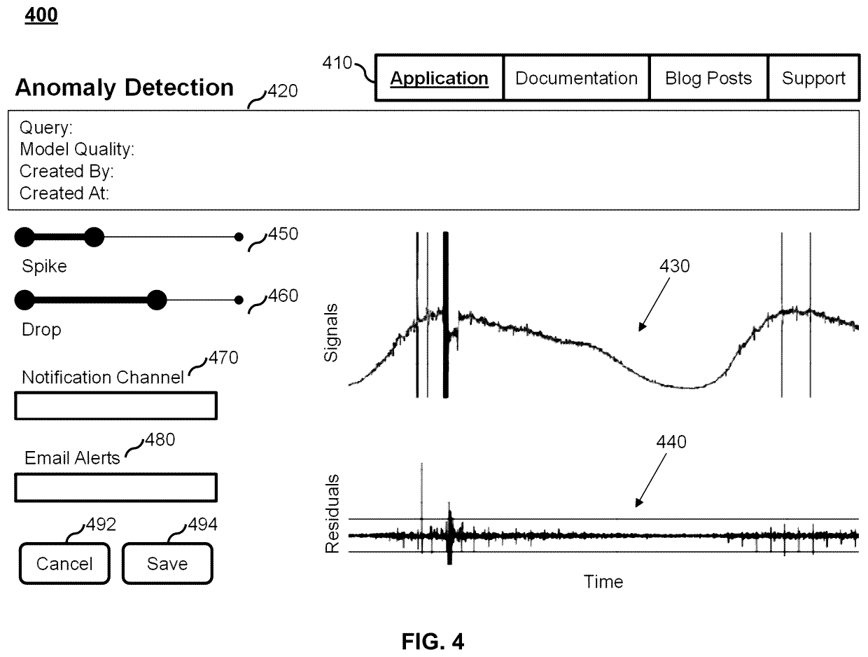

The generated models and/or corresponding parameters may be independently maintained, managed, and/or adjusted, for example, such as spike and drop thresholds in a univariate (UV) flow and/or model sensitivity and hold variables in a multivariate (MV) flow. FIG. 4 illustrates an example user interface 400 for model onboarding of an anomaly detection system, in accordance with some embodiments. As shown in FIG. 4, the user interface 400 includes an app section 410, a feature section 420, and signals 430, 440. The app section 410 may provide application options related to an anomaly detection job. The feature section 420 may include various features related to the anomaly detection job. The example signal 430 in FIG. 4 shows some anomalies detected in view of its corresponding residual signal 440 over time. In some examples, a user of the user interface 400 may adjust a spike threshold 450 and/or a drop threshold 460 for detecting an application anomaly. In addition, the user interface 400 shows a notification channel 470 specifying a channel for sending a notification regarding the signals and any detected anomaly. The user interface 400 may further include email alerts 480 specifying emails receiving anomaly alerts upon a detection of an anomaly. The configurations related to the anomaly detection job shown in the user interface 400 may be saved by the user via a save button 494, or cancelled by the user via a cancel button 492.

Referring back to FIG. 3, in various embodiments, the SMO 304 is configured to provide a variety of services including: e.g. signal service by a signal collector 331, a model orchestrator service by a model orchestrator 332, an inference service by an inference orchestrator 334, signal jobs by a signal updater 336, and/or alert services by an alert generator 338. Each of the services may be designed to facilitate an onboarding UI for effective signal and model management. The services of the SMO 304 may also be used to generate predictions and alerts, which may be subsequently exposed to the MMD 386 in the form of metrics.

In some embodiments, a first step of model onboarding involves signal registration, achieved through a Create Retrieve Update and Delete (CRUD) API interface. During signal registration, a specific signal name and an associated query may be recorded. Once a signal is registered, a predetermined period of time series data may be collected from the MMD 386 (for example, a maximum period held by the MMD 386) and saved in the signal dataset 385 in the data store 308. In some embodiments, a daily signal job related to onboarding and maintenance may be provided by the signal updater 336 to ensure such data remains current with every new run. Then during a training phase of the system, model training and registration can be performed utilizing the underlying interface of the MLO 306 for model training. A model may be associated with an appropriate communication channel for publishing alert events. In some embodiments, the API contracts offered by the model orchestrator 332 may be configured to connect signals, models, and communication channels. For example, the model orchestrator 332 may provide all the history of the selected signals and pass it to the model trainer 340 for training a model.

In some embodiments, the inference orchestrator 334 can perform an inference for all registered models on a predetermined periodic (e.g., minute-by-minute) basis through the components of the MLO 306, during an inference phase of the system. In some examples, the inference orchestrator 334 may call the model orchestrator 332 to determine which signals belong to which model, and collect signals related to one or more active models via the signal collector 331, and pass the signals with a corresponding model ID to the model hosting predictor 350 in the MLO 306 to predict inference based on a model with the corresponding model ID.

The inference orchestrator 334 may push alert events through the alert generator 338, for example, upon the detection of an anomaly. For example, when a prediction score generated by the model hosting predictor 350 during the inference phase is larger than an anomaly threshold, an anomaly detection signal together with the prediction score and a corresponding explainability signal may be sent back to the inference orchestrator 334, which may request the alert generator 338 to generate an anomaly alert to notify a user. The inference orchestrator 334 may further expose a corresponding anomaly metric and a predicted signal value into the MMD 386. The integration of metrics into the MMD 386 may enable effective visualization of the original and predicted signals and associated anomalies on a graphical dashboard.

In some examples, the anomaly alert may be sent via a channel (e.g. text message, phone call, incident ticket, etc.) different from the graphical dashboard showing the original and predicted signals. In some examples, the anomaly alert may be sent together with mitigation and root cause information for the detected anomaly. In some examples, one or more mitigation actions will be automatically taken upon detection of the anomaly, without waiting for an approval from a user. For example, the system can perform a self-mitigation based on a pattern or root cause of the detected anomaly.

In some examples, when a malicious user performs a network attack by hitting one region with a high traffic, an anomaly can be detected by a performance metric, e.g. a surge on the network traffic, a spike on the CPU usage, a spike on the memory occupancy, a spike of system latency, etc. Based on different performance metrics associated with the detected anomaly, the system can determine a type of the network attack, and automatically perform one or more self-mitigation actions (e.g. blocking a corresponding IP address) to remedy or mitigate the anomaly accordingly.

In some examples, when a driver assigned to deliver an order deviates from a normal driving pattern, an anomaly can be detected by a performance metric related to order delivery (e.g. driving route or delivery time). Based on historical data of the driver and other drivers, the system can automatically perform one or more self-mitigation actions (e.g. calling the driver immediately, replacing the driver with another driver, etc.) to remedy or mitigate the anomaly accordingly.

To accommodate the increasing number of models and signals, the inference orchestrator 334 may implement a distributed load sharing approach that may be horizontally scalable. A host discovery tool and consensus protocol may be utilized to select a leader host that orchestrates a load sharing process. In some examples, upon the creation of a new service pod, a discovery service may propagate a creation event to all inference service pods, rendering the new pod discoverable. In some embodiments, a consensus algorithm may be leveraged to elect a leader pod within a predetermine time period (e.g., a few seconds) to dispatch inference responsibilities to other stateless workers, ensuring fault tolerance. The leader pod may distribute the load to all non-leader pods using a low latency protocol. The non-leader pods may perform prediction requests through the components of the MLO 306, assigning prediction duties to prevent the occurrence of CPU spikes on the leader as well as other potential system health issues. In some embodiments, the leader only distributes responsibilities and never itself becomes a bottleneck.

In some embodiments, the alert generator 338 may generate anomaly alerts and provide a CRUD interface to publish the anomaly alerts through one or more notification platforms. In some examples, user activities such as deleting or snoozing alerts may be seamlessly executed through interface elements provided on a notification interface. In some embodiments, the alert data may be used to re-calibrate models using the model monitor 309, as discussed in details later.

In some embodiments, the components of the MLO 306 may serve as building blocks to provide an interface for typical machine learning system requirements such as training, online inference and model configuration. Interactions with the components of the MLO 306 may take place through the use of a versatile API-driven interface to ensure that a wide range of machine learning requirements can be fulfilled. In some embodiments, components and/or services of the MLO 306 may be designed to be stateless in nature, enabling the disclosed system to scale horizontally.

In some embodiments, the model hosting predictor 350 surfaces prediction APIs that provide the system online inference capabilities. In some examples, the model hosting predictor 350 may support many (e.g. more than 4000) model inferences per minute while accommodating various model types that may use entirely different machine learning stacks. Some embodiments address a primary challenge in optimizing the model inference speed and scalability. The inference speed of a worker may be inversely correlated to the scaling cost of the entire system. A higher inference time per worker can imply more concurrent workers are required to perform prediction within a one-minute time period, which may be translated into higher scaling costs for onboarding additional models into the system. In some embodiments, in order to optimize latency and scaling cost, a distributed hosting cache 360 may be used and a multi-tiered load-balancing approach may be employed.

In some embodiments, the distributed hosting cache 360 stores serialized models in memory for swift retrieval prior to prediction. When a model is not already present in cache, the model may be fetched from the model store 383 and inserted into the cache for future use, significantly improving prediction speed and ensuring limitless scalability by decoupling model store from prediction, making the service stateless in some embodiments. Each hosting pod in the distributed hosting cache 360 may include several light-weight asynchronous workers. In some embodiments, a load-balancing at the worker, pod, and/or region levels may be provided, enhancing the resilience and fault tolerance of the disclosed system. When a worker, e.g., the most fundamental unit of prediction, is highly optimized, the efficiency can inherently elevate the performance of the system. In some embodiments, in order to ensure resiliency is maintained throughout the life of the system, system changes may undergo a thorough series of chaos testing.

In some embodiments, a model configurator 370 in the MLO 306 can provide a CRUD API interface to interact with the model registry 381 and a model configuration in the model store 383. In some embodiments, the model registry 381 may serve as a record of all onboarded models, current versions, and metadata such as model type, training parameters (including holding and smoothing windows), and/or static thresholds. The SMO 304 may utilize the model registry 381 to identify all models for which it needs to periodically deliver and publish inferences. The model configuration in the model store 383 may serve as a record of configurations specific to the model type, including parameters like minimum training length, minimum prediction step, and/or other model-specific parameters. These configurations may be used by the SMO 304 to prepare the appropriate payload for real-time inferences and/or by a model trainer 340 in the MLO 306 to set the default values of optional training parameters.

In some embodiments, the model trainer 340 may provide APIs that initiate a training process that creates versioned model artifacts capable of being used in inference. In some examples, the API contract may provide the capability to execute both model performance preview and training. While generating the model preview, a smaller subset of a training dataset (e.g. the signal dataset 385) may be used to fast-train a temporary model intended to provide a sense of the effectiveness of the model in detecting anomalies. If the effectiveness is satisfactory, the system may proceed with model training. In some embodiments, the model trainer 340 may utilize a predetermined period (e.g., 21 days) of historical data to train the model and create a model artifact that is stored in the model store 383.

In some embodiments, a training process performed by the model trainer 340 starts with fetching the historical data from the data store 308 and conducting data pre-processing at operation 342. The training process may proceed to operation 344 for model selection in which the appropriate model training routine is identified and executed based on the model type specified in an API request. Once the model is trained, the model may go through a model enrichment operation 346 for further refinement, for example, to account for any smoothing or holding specified in the API request, and tune a model based on a specific application type, functionality or domain. The training process may include providing multivariate models at the model explainability operation 348 to generate a model explainability object, which can provide insight into the underlying cause of the detected anomaly for root cause analysis. The final model object may be packaged, serialized, and stored in the model store 383. When a model is to be registered into production (e.g. as specified in the API request), the model metadata may be passed on to the model configurator 370 which can update the model registry 381 accordingly. When a model is to be re-trained, updated or deleted (e.g. based on a monitoring result of the model monitor 309), the model ID may be passed from the model monitor 309 to the model configurator 370 to re-train or delete the model and update the model registry 381 accordingly.

In some embodiments, model training is a complex and time-consuming process that requires significant computational resources. The disclosed system can maintain stability and scalability while being cost-efficient. A serverless framework tailored to the specific requirements of model training, considering its infrequent usage and significant resource consumption, may be applied. The serverless framework may automatically scale down to and up from zero, ensuring that the system only utilizes resources when there is a training request coming in.

In some embodiments, a multiprocessing job may be implemented to identify data and concept drift within each model. In some examples, the identification of drift may be based on a deviation of a statistical distribution of signal data compared to training data and/or the number of daily anomalies triggered. When a model is found to be faulty, a preview graph visualizing models from both pre model re-training and post model re-training, may be dispatched via a notification. In some embodiments, a model re-training automatically commences following customer approval, a timeout, and/or any other suitable trigger. The drift detection process, alone or in conjunction with feedback data, may be used to refine model parameters during re-training of models. In some embodiments, data drift detection may utilize one or more statistical methods, such as Kolmogorov-Smirnov test statistic, Population Stability Index (PSI), Kullback-Leibler divergence, Jensen-Shannon divergence, Wasserstein distance, etc.

In some embodiments, various models and model-enriching techniques are provided to curate machine learning solutions for diverse users and may require numerous iterations of model building. In some embodiments, an end-to-end process of model onboarding is applied to address these requirements. In some embodiments, AIDR is an amalgamation of machine learning predictive models, statistical estimators, explainable artificial intelligence (AI) algorithms, and/or rule-based filtering. A core machine learning model inventory may accommodate a diverse set of algorithms, for example, ranging from regression-based statistical models to advanced deep learning models. The core machine learning model inventory may provide various options for different solutions. For example, deep learning models may demonstrate superior predictive performance but often suffer from performance bottlenecks in production and require additional attention. Less complicated solutions may provide a good fit for fast user adoption.

In some embodiments, an ensemble model architecture combines the core predictive algorithms complemented by the optional add-ons to serve robust end-to-end solutions. A core of the anomaly detection engine may provide machine learning models like Auto-Regressive Integrated Moving Average (ARIMA), XGBoost, Isolation Forest (IF), and/or Variational Autoencoder models, in conjunction with Inter-Quartile Range and/or Empirical Quantiles to estimate respective decision boundaries for anomaly classification. These machine learning models may be provided as options for model selection at the operation 344.

In some embodiments, model enhancement techniques may be configured at the operation 346 to assist the core algorithms. For example, model enhancement techniques may be configured to address noise injection, hold/smoothing, rule-based filtering, explainable AI, and/or seasonality. In some embodiments, due to the data availability constraints in the data store 308, machine learning models may encounter sampling bias on the training data, for example, during the onboarding phase. A noise injection strategy may be applied in the training data to prevent overfitting of the trained model and to provide immunity to benign spikes and/or drops during inference. The predictive models may be complimented with exponential smoothing and/or hold logic on the anomaly scores to make alerts resistant to temporary spikes and/or drops during inference. Unlike intrusion detection, an anomaly score detection for failure management may have a higher tolerance for data behavior change. A detection alert may be held back until the number of anomalous time points encountered within a given lookback window exceeds a certain limit.

In some embodiments, to further reduce the false positive rate, a rule-based filter is implemented to act as a safety net for extreme cases through several static thresholds. These thresholds may incorporate domain knowledge in the model. In some examples, the thresholds may be determined by, for example, service-level objectives (SLO).

In some embodiments, the disclosed systems and methods provide model explainability at the operation 348, where a set of SHAP (SHapley Additive exPlanations) may be implemented using explainers to act as surrogate models on top of the core predictive models. When an anomaly is detected, the SHAP may help to identify the major contributing signals. Additionally, when seasonality is observed in the input streaming signals, a moving median smoothing-based seasonality extraction algorithm (MEDIFF) may be used to extract a seasonality component.

Algorithm 1 below shows a schematic of one embodiment to demonstrate the workflow of the system with respect to an incoming request being processed through the pipeline.

Algorithm 1: Prediction flow of anomaly
detection on streaming data

Data: A rolling window of length n sliced from the input

streaming data

Result: is_anomaly = True | False
if Number of time points breaching the static thresholds ≤

| hold tolerance then | |
|---|---|
| \| | is_anomaly = Rule based decision |

else

| | |
|---|---|
| \| | Seasonal_Component ← MEDIFF(Data) ** If |
| \| | applicable |
| \| | Anomaly_Scores ← |
| \| | Core model prediction score(Data, Seasonal_Component) |
| \| | Anomaly_Counts |
| \| | ← Exponential_smoothing(Anomaly_Scores) |
| \| | is_anomaly |
| \| | ← Apply_hold_tolerance(Anomaly_Counts) |

end

In some embodiments, a quick model on boarding process may result in future cost for surgical changes during future iterations. Each algorithm (e.g., each model) may be w rapped into a self-contained capsule that may be easily plugged into ensemble solutions, enabling initial drafts to be adaptive to the iterative requirement changes of the downstream uses.

In some embodiments, as described in FIG. 3, a self-onboarding process 320 for models may be provided through a user interface supported by the SMO APIs. One or more plug-and-play model building interfaces, complemented with default configurations, may provide an automated machine learning solution to users with minimal machine learning know-how. A bulk onboarding may be supported through additional processes, e.g. the assisted onboarding process 310 in FIG. 3. For example, some models onboarded in bulk may suffer from concept drift, resulting in quiet and/or noisy models. A self-healing solution may be applied to perform drift detection and autonomous re-training, as discussed above.

In some embodiments, the disclosed systems and methods provide an autonomous model maintenance system configured to facilitate a focus on new use cases with unique problem statements. The disclosed configuration-driven model-building pipeline may enable a rapid iteration through potential solutions during an ideation phase. A centralized artifact store (e.g. the data store 308) may reduce experimentation time to find a problem-solution fit while building models, such as proof-of-concept and/or initial models. The non-intrusive nature of the algorithm (e.g., machine learning) plug-ins can enable a quick prototyping without risking the possibility of incremental efforts in the future.

The disclosed systems and methods can provide an improvement to existing machine learning generation processes and models. In particular, the disclosed AIDR system may provide improved anomaly detection, such as providing early detection of major incidents, prevention of incidents, etc. The disclosed system and processes may further generate models that can detect alerts or impending issues not detectable by existing models or processes. The disclosed system and methods may further provide a reduction in mean-time-to-triage (MTTT), trace issues to specific sources and/or network participants, monitor network connections to detect distributed-denial-of-service (DDoS) attacks, detection of bad queries without overloading a database, coverage of key business signals (including e-commerce traffic and metrics tracking online user journey) and critical application and network health metrics.

The disclosed systems and methods can provide a comprehensive, innovative, and scalable anomaly detection solution that harnesses statistical and machine learning models to deliver accurate, real-time alerts to production systems. In various embodiments, the disclosed systems and methods provide ease of use for users with little to no machine learning know-how, an API-driven framework, a scalable cloud-native design, utilization of advanced algorithms bolstered by non-intrusive and algorithm plug-ins, and/or implementation of a self-healing module for automated model life-cycle management. In some embodiments, the disclosed system and methods may be integrated with a root cause recommendation (RCR) system and generative AI empowered chatbots to provide an end-to-end incident detection and triaging experience.

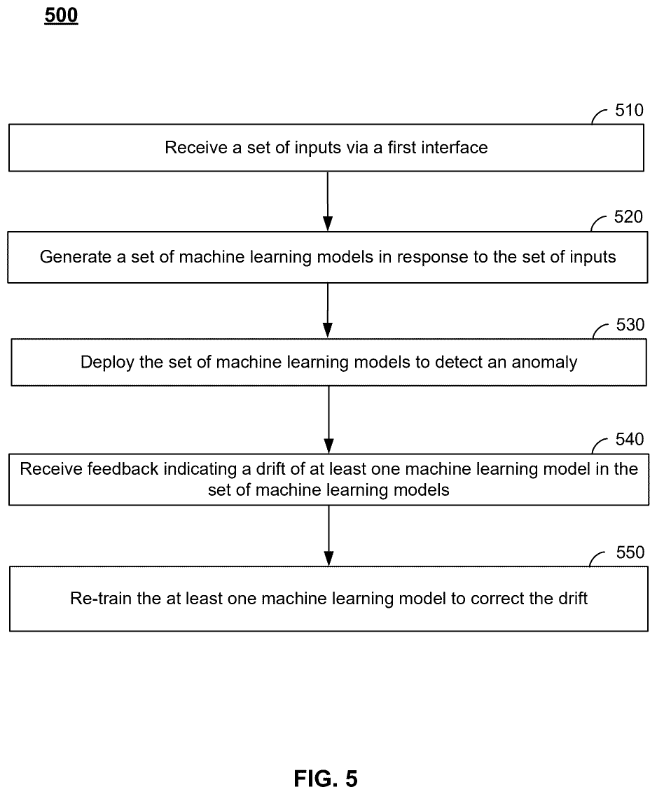

FIG. 5 shows a flowchart illustrating an example method 500 for detecting anomalies based on machine learning, in accordance with some embodiments. In some embodiments, the method 500 can be carried out by a system including one or more computing devices, such as the anomaly detection computing device 102 and/or the cloud-based engine 121 of FIG. 1. Beginning at operation 510, a set of inputs is received via a first interface. At operation 520, a set of machine learning models is generated in response to the set of inputs. At operation 530, the set of machine learning models is deployed to detect an anomaly. At operation 540, feedback is received to indicate a drift of at least one machine learning model in the set of machine learning models. At operation 550, the at least one machine learning model is re-trained to correct the drift.

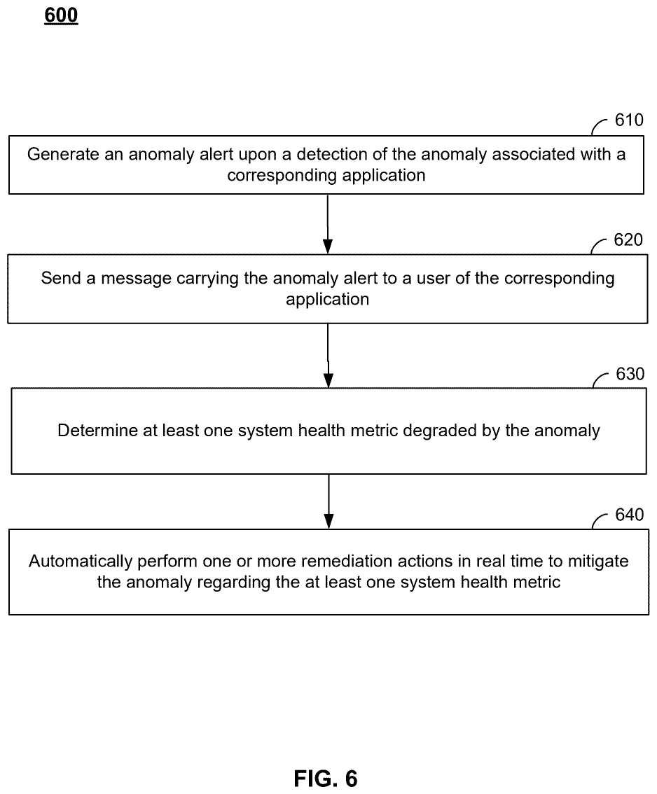

FIG. 6 shows a flowchart illustrating an example method 600 for mitigating a detected anomaly, in accordance with some embodiments. In some embodiments, the method 600 can be carried out by a system including one or more computing devices, such as the anomaly detection computing device 102 and/or the cloud-based engine 121 of FIG. 1. Beginning at operation 610, an anomaly alert is generated upon a detection of the anomaly associated with a corresponding application. At operation 620, a message carrying the anomaly alert is sent to a user of the corresponding application. At operation 630, at least one system health metric degraded by the anomaly is determined. At operation 640, one or more remediation actions are automatically performed in real time to mitigate the anomaly regarding the at least one system health metric. Example system health metrics may include signal response error rate, system latency, crash loop, CPU usage, etc. In some embodiments, an anomaly may be determined to degrade a business related metric, e.g. orders per minute, clicks per minute, etc.

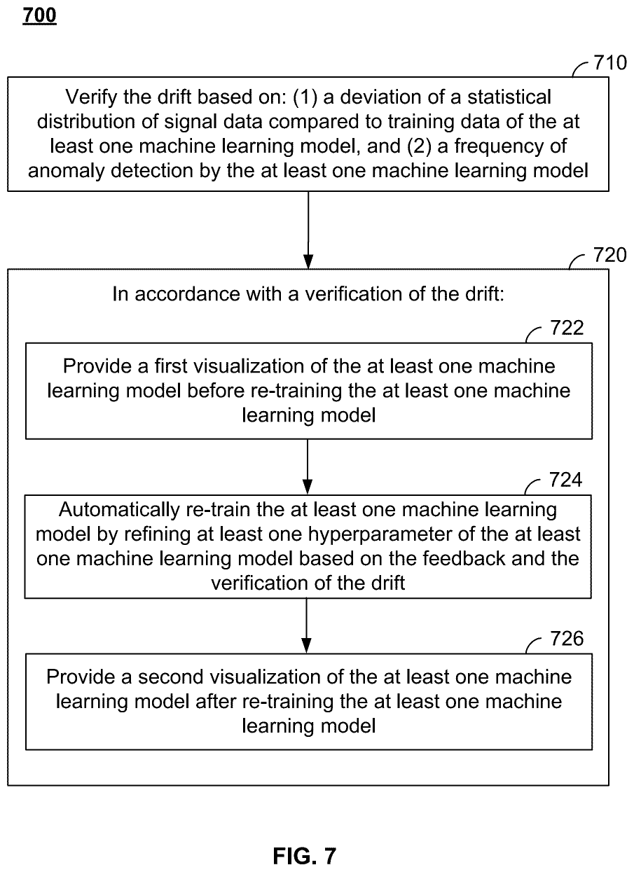

FIG. 7 shows a flowchart illustrating an example method 700 for re-training at least one machine learning model, in accordance with some embodiments. In some embodiments, the method 700 can be carried out by a system including one or more computing devices, such as the anomaly detection computing device 102 and/or the cloud-based engine 121 of FIG. 1. In some embodiments, the method 700 can be performed as part of the operation 550 of the example method 500 in FIG. 5.

Beginning at operation 710, the drift is verified based on: (1) a deviation of a statistical distribution of signal data compared to training data of the at least one machine learning model, and (2) a frequency of anomaly detection by the at least one machine learning model. At operation 720, in accordance with a verification of the drift, sub-operations 722-726 are performed. At sub-operation 722, a first visualization of the at least one machine learning model is provided before re-training the at least one machine learning model. At sub-operation 724, the at least one machine learning model is automatically re-trained by refining at least one hyperparameter of the at least one machine learning model based on the feedback and the verification of the drift. At sub-operation 726, a second visualization of the at least one machine learning model is provided after re-training the at least one machine learning model.

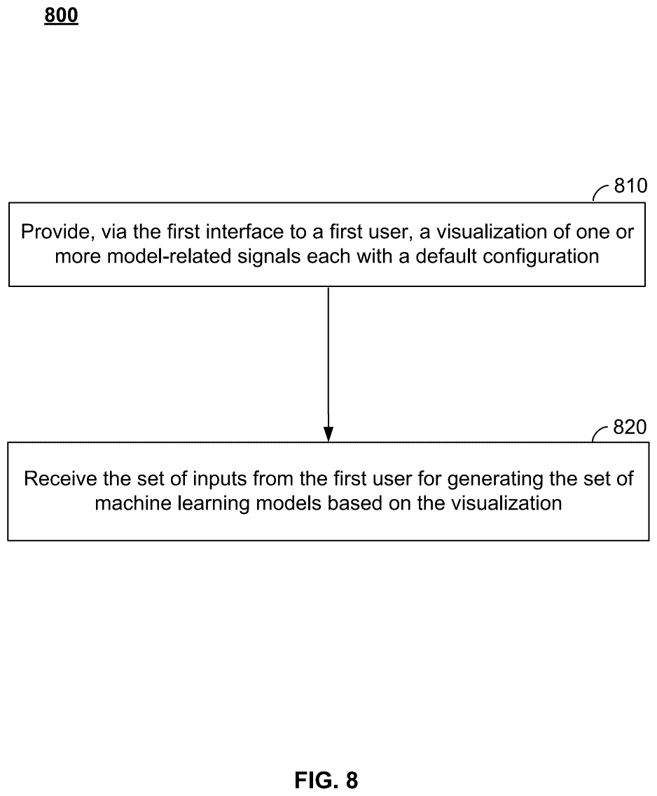

FIG. 8 shows a flowchart illustrating an example method 800 for receiving a set of inputs, in accordance with some embodiments. In some embodiments, the method 800 can be carried out by a system including one or more computing devices, such as the anomaly detection computing device 102 and/or the cloud-based engine 121 of FIG. 1. In some embodiments, the method 800 can be performed as part of the operation 510 of the example method 500 in FIG. 5. Beginning at operation 810, a visualization is provided to represent one or more model-related signals each with a default configuration via the first interface to a first user. At operation 820, the set of inputs is received from the first user for generating the set of machine learning models based on the visualization.

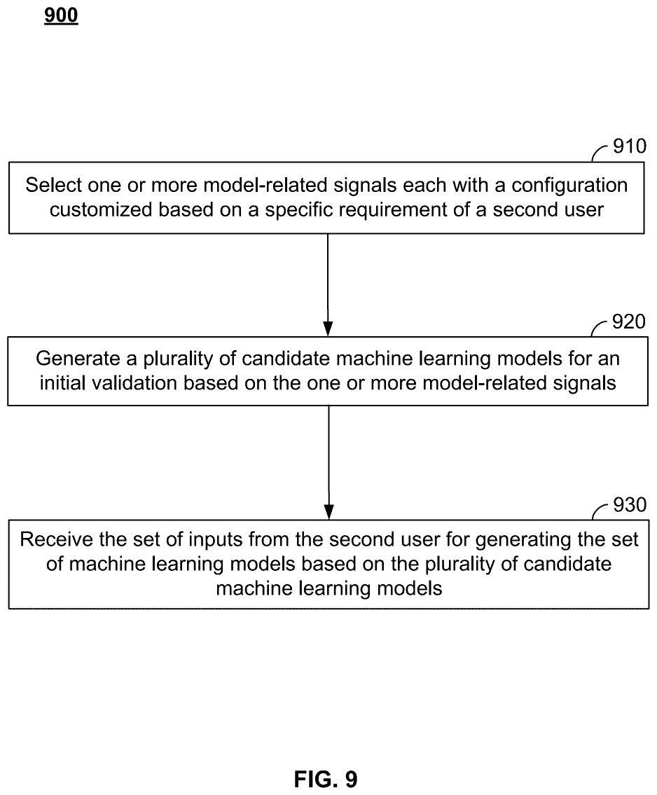

FIG. 9 shows a flowchart illustrating another example method 900 for receiving a set of inputs, in accordance with some embodiments. In some embodiments, the method 900 can be carried out by a system including one or more computing devices, such as the anomaly detection computing device 102 and/or the cloud-based engine 121 of FIG. 1. In some embodiments, the method 900 can be performed as part of the operation 510 of the example method 500 in FIG. 5. Beginning at operation 910, one or more model-related signals are selected, each with a configuration customized based on a specific requirement of a second user. At operation 920, a plurality of candidate machine learning models is generated for an initial validation based on the one or more model-related signals. At operation 930, the set of inputs is received from the second user for generating the set of machine learning models based on the plurality of candidate machine learning models.

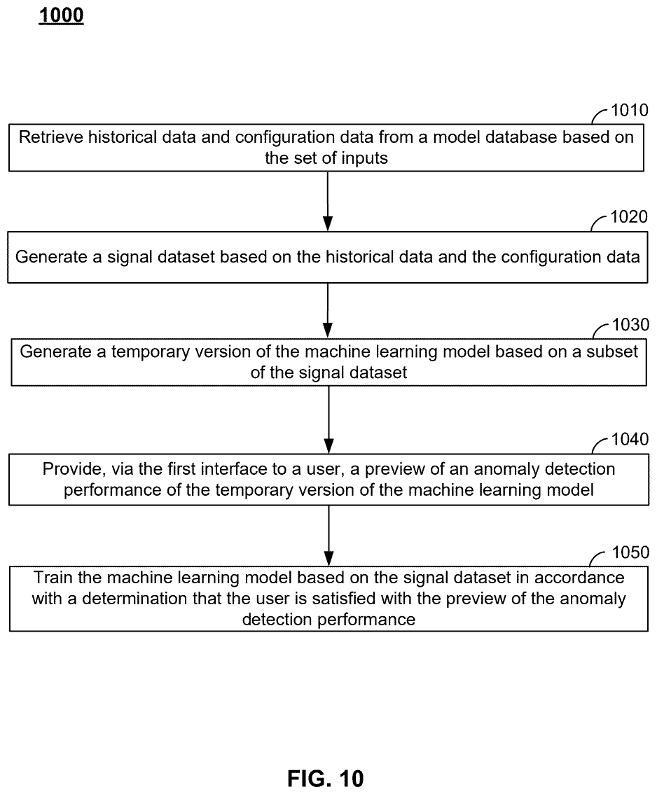

FIG. 10 shows a flowchart illustrating an example method 1000 for generating a set of machine learning models, in accordance with some embodiments. In some embodiments, the method 1000 can be carried out by a system including one or more computing devices, such as the anomaly detection computing device 102 and/or the cloud-based engine 121 of FIG. 1. In some embodiments, the method 1000 can be performed as part of the operation 520 of the example method 500 in FIG. 5, to train each machine learning model in the set of machine learning models. Beginning at operation 1010, historical data and configuration data are retrieved from a model database based on the set of inputs. At operation 1020, a signal dataset is generated based on the historical data and the configuration data. At operation 1030, a temporary version of the machine learning model is generated based on a subset of the signal dataset. At operation 1040, a preview is provided for an anomaly detection performance of the temporary version of the machine learning model via the first interface to a user. At operation 1050, the machine learning model is trained based on the signal dataset in accordance with a determination that the user is satisfied with the preview of the anomaly detection performance.

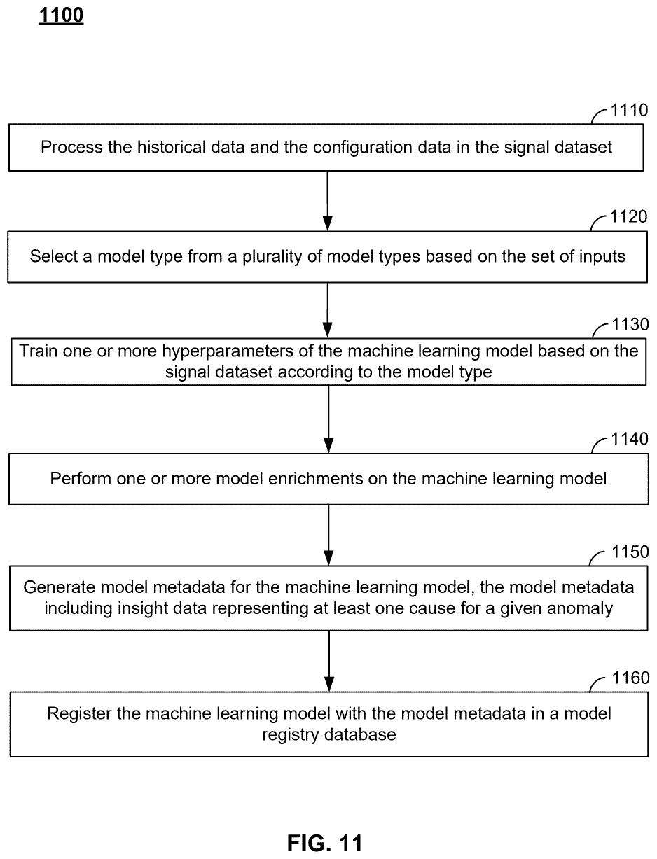

FIG. 11 shows a flowchart illustrating an example method 1100 for training a machine learning model, in accordance with some embodiments. In some embodiments, the method 1100 can be carried out by a system including one or more computing devices, such as the anomaly detection computing device 102 and/or the cloud-based engine 121 of FIG. 1. In some embodiments, the method 1100 can be performed as part of the operation 1050 of the example method 1000 in FIG. 10.

Beginning at operation 1110, the historical data and the configuration data are processed in the signal dataset. At operation 1120, a model type is selected from a plurality of model types based on the set of inputs. At operation 1130, one or more hyperparameters of the machine learning model are trained based on the signal dataset according to the model type. At operation 1140, one or more model enrichments are performed on the machine learning model. At operation 1150, model metadata is generated for the machine learning model, the model metadata including insight data representing at least one cause for a given anomaly. At operation 1160, the machine learning model is registered with the model metadata in a model registry database.

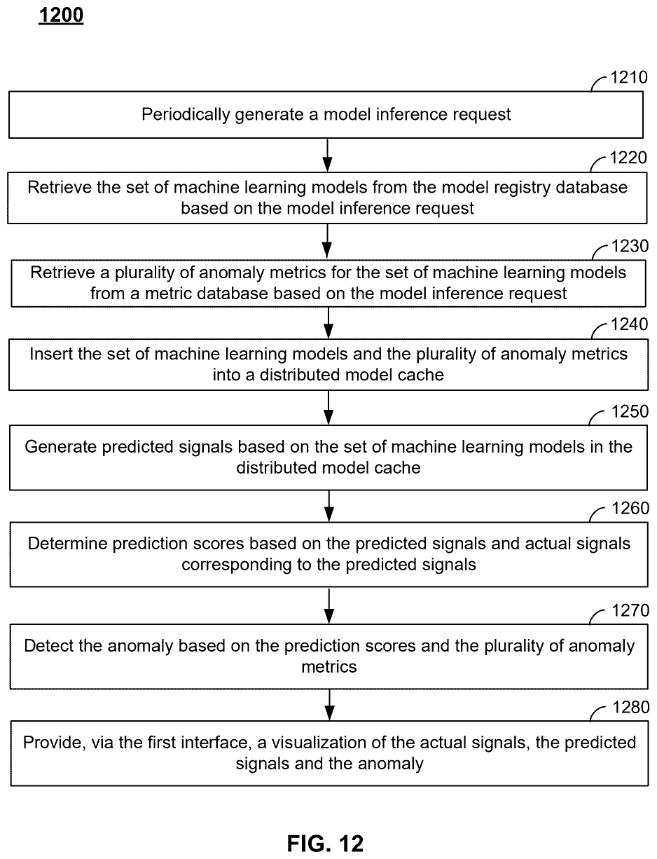

FIG. 12 shows a flowchart illustrating an example method 1200 for deploying a set of machine learning models, in accordance with some embodiments. In some embodiments, the method 1200 can be carried out by a system including one or more computing devices, such as the anomaly detection computing device 102 and/or the cloud-based engine 121 of FIG. 1. In some embodiments, the method 1200 can be performed as part of the operation 530 of the example method 500 in FIG. 5.

Beginning at operation 1210, a model inference request may be periodically generated. At operation 1220, the set of machine learning models may be retrieved from the model registry database based on the model inference request. At operation 1230, a plurality of anomaly metrics can be retrieved for the set of machine learning models from a metric database based on the model inference request. At operation 1240, the set of machine learning models and the plurality of anomaly metrics may be inserted into a distributed model cache. At operation 1250, predicted signals can be generated based on the set of machine learning models in the distributed model cache. At operation 1260, prediction scores can be determined based on the predicted signals and actual signals corresponding to the predicted signals. At operation 1270, the anomaly may be detected based on the prediction scores and the plurality of anomaly metrics. At operation 1280, a visualization of the actual signals, the predicted signals and the anomaly may be provided via the first interface.

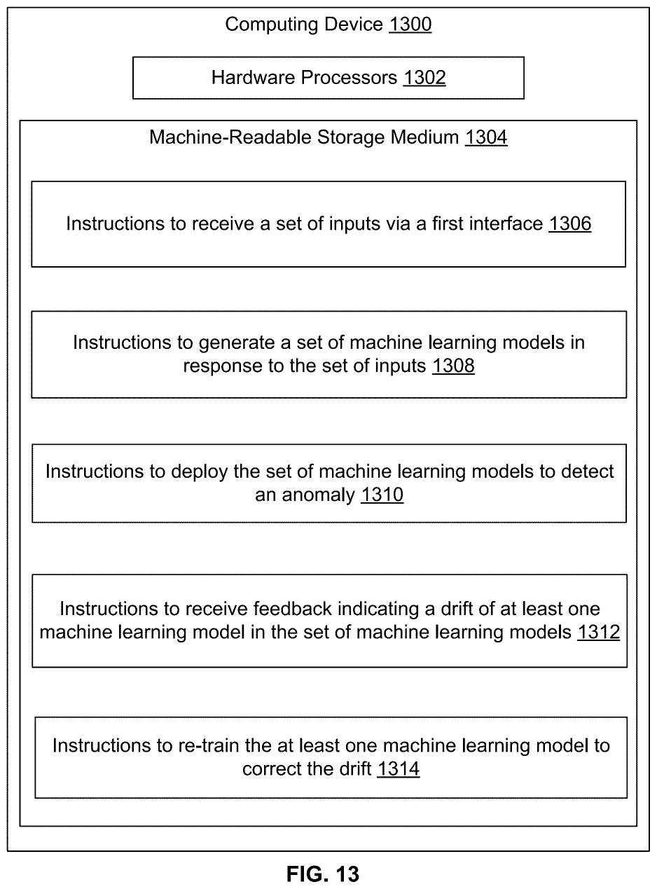

FIG. 13 depicts an example system 1300 (e.g. a computing device) for detecting anomalies based on machine learning, including a machine-readable medium 1304 encoded with example instructions executable by processing resource 1302, e.g. hardware processors, in accordance with some embodiments. In some implementations, the system 1300 may be useful for implementing aspects of the anomaly detection computing device 102 of FIG. 1. In some implementations, functionality described with respect to FIG. 1 may be included in the instructions encoded on machine-readable medium 1304.

The processing resource 1302 may include a microcontroller, a microprocessor, central processing unit core(s), an ASIC, an FPGA, and/or other hardware device suitable for retrieval and/or execution of instructions from the machine-readable medium 1304 to perform functions related to various examples. Additionally or alternatively, the processing resource 1302 may include or be coupled to electronic circuitry or dedicated logic for performing some or all of the functionality of the instructions described herein.

The machine-readable medium 1304 may be any medium suitable for storing executable instructions, such as RAM, ROM, EEPROM, flash memory, a hard disk drive, an optical disc, or the like. In some example implementations, the machine-readable medium 1304 may be a tangible, non-transitory medium. The machine-readable medium 1304 may be disposed within the system 1300 in which case the executable instructions may be deemed installed or embedded on the system. Alternatively, the machine-readable medium 1304 may be a portable (e.g., external) storage medium, and may be part of an installation package.

As described further herein below, the machine-readable medium 1304 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 13.

The machine-readable medium 1304 includes instructions 1306-1314. Instructions 1306, when executed, cause the processing resource 1302 to receive a set of inputs via a first interface. The instructions 1308, when executed, cause the processing resource 1302 to generate a set of machine learning models in response to the set of inputs. The instructions 1310, when executed, cause the processing resource 1302 to deploy the set of machine learning models to detect an anomaly. The instructions 1312, when executed, cause the processing resource 1302 to receive feedback indicating a drift of at least one machine learning model in the set of machine learning models. The instructions 1314, when executed, cause the processing resource 1302 to re-train the at least one machine learning model to correct the drift.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROM s, CD-ROM s, DVD-ROM s, BD-ROM s, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
receive a set of inputs via a first interface;
generate a set of machine learning models in response to the set of inputs;
deploy the set of machine learning models to detect an anomaly;
receive feedback indicating a drift of at least one machine learning model in the set of machine learning models; and
re-train the at least one machine learning model to correct the drift.

2. The system of claim 1, wherein instructions, when executed, further cause the processor to:
generate an anomaly alert upon a detection of the anomaly associated with a corresponding application;
send a message carrying the anomaly alert to a user of the corresponding application;
determine at least one system health metric degraded by the anomaly; and
automatically perform one or more remediation actions in real time to mitigate the anomaly regarding the at least one system health metric.

3. The system of claim 1, wherein the at least one machine learning model is re-trained based at least in part by:
verifying the drift based on: (1) a deviation of a statistical distribution of signal data compared to training data of the at least one machine learning model, and (2) a frequency of anomaly detection by the at least one machine learning model; and
in accordance with a verification of the drift,
providing a first visualization of the at least one machine learning model before re-training the at least one machine learning model,
automatically re-training the at least one machine learning model by refining at least one hyperparameter of the at least one machine learning model based on the feedback and the verification of the drift, and
providing a second visualization of the at least one machine learning model after re-training the at least one machine learning model.

4. The system of claim 1, wherein the set of inputs is received based at least in part by:
providing, via the first interface to a first user, a visualization of one or more model-related signals each with a default configuration; and
receiving the set of inputs from the first user for generating the set of machine learning models based on the visualization.

5. The system of claim 1, wherein the set of inputs is received based at least in part by:
selecting one or more model-related signals each with a configuration customized based on a specific requirement of a second user;
generating a plurality of candidate machine learning models for an initial validation based on the one or more model-related signals; and
receiving the set of inputs from the second user for generating the set of machine learning models based on the plurality of candidate machine learning models.

6. The system of claim 1, wherein each machine learning model in the set of machine learning models is generated based at least in part by:
retrieving historical data and configuration data from a model database based on the set of inputs;
generating a signal dataset based on the historical data and the configuration data;
generating a temporary version of the machine learning model based on a subset of the signal dataset;
providing, via the first interface to a user, a preview of an anomaly detection performance of the temporary version of the machine learning model; and
training the machine learning model based on the signal dataset in accordance with a determination that the user is satisfied with the preview of the anomaly detection performance.

7. The system of claim 6, wherein training the machine learning model comprises:
processing the historical data and the configuration data in the signal dataset;
selecting a model type from a plurality of model types based on the set of inputs;
training one or more hyperparameters of the machine learning model based on the signal dataset according to the model type;
performing one or more model enrichments on the machine learning model;
generating model metadata for the machine learning model, wherein the model metadata includes insight data representing at least one cause for a given anomaly; and
registering the machine learning model with the model metadata in a model registry database.

8. The system of claim 7, wherein the set of machine learning models is deployed based at least in part by:
periodically generating a model inference request;
retrieving the set of machine learning models from the model registry database based on the model inference request;
retrieving a plurality of anomaly metrics for the set of machine learning models from a metric database based on the model inference request;
inserting the set of machine learning models and the plurality of anomaly metrics into a distributed model cache;
generating predicted signals based on the set of machine learning models in the distributed model cache;
determining prediction scores based on the predicted signals and actual signals corresponding to the predicted signals;
detecting the anomaly based on the prediction scores and the plurality of anomaly metrics; and
providing, via the first interface, a visualization of the actual signals, the predicted signals and the anomaly.

9. A computer-implemented method, comprising:
receiving a set of inputs via a first interface;
generating a set of machine learning models in response to the set of inputs;
deploying the set of machine learning models to detect an anomaly;
receiving feedback indicating a drift of at least one machine learning model in the set of machine learning models; and
re-training the at least one machine learning model to correct the drift.

10. The computer-implemented method of claim 9, further comprising:
generating an anomaly alert upon a detection of the anomaly associated with a corresponding application;
sending a message carrying the anomaly alert to a user of the corresponding application;
determining at least one system health metric degraded by the anomaly; and
automatically performing one or more remediation actions in real time to mitigate the anomaly regarding the at least one system health metric.

11. The computer-implemented method of claim 9, wherein re-training the at least one machine learning model comprises:
verifying the drift based on: (1) a deviation of a statistical distribution of signal data compared to training data of the at least one machine learning model, and (2) a frequency of anomaly detection by the at least one machine learning model; and
in accordance with a verification of the drift,
providing a first visualization of the at least one machine learning model before re-training the at least one machine learning model,
automatically re-training the at least one machine learning model by refining at least one hyperparameter of the at least one machine learning model based on the feedback and the verification of the drift, and
providing a second visualization of the at least one machine learning model after re-training the at least one machine learning model.

12. The computer-implemented method of claim 9, wherein receiving the set of inputs comprises:
providing, via the first interface to a first user, a visualization of one or more model-related signals each with a default configuration; and
receiving the set of inputs from the first user for generating the set of machine learning models based on the visualization.

13. The computer-implemented method of claim 9, wherein receiving the set of inputs comprises:
selecting one or more model-related signals each with a configuration customized based on a specific requirement of a second user;
generating a plurality of candidate machine learning models for an initial validation based on the one or more model-related signals; and
receiving the set of inputs from the second user for generating the set of machine learning models based on the plurality of candidate machine learning models.

14. The computer-implemented method of claim 9, wherein each machine learning model in the set of machine learning models is generated based at least in part by:
retrieving historical data and configuration data from a model database based on the set of inputs;
generating a signal dataset based on the historical data and the configuration data;
generating a temporary version of the machine learning model based on a subset of the signal dataset;
providing, via the first interface to a user, a preview of an anomaly detection performance of the temporary version of the machine learning model; and
training the machine learning model based on the signal dataset in accordance with a determination that the user is satisfied with the preview of the anomaly detection performance.

15. The computer-implemented method of claim 14, wherein training the machine learning model comprises:
processing the historical data and the configuration data in the signal dataset;
selecting a model type from a plurality of model types based on the set of inputs;
training one or more hyperparameters of the machine learning model based on the signal dataset according to the model type;
performing one or more model enrichments on the machine learning model;
generating model metadata for the machine learning model, wherein the model metadata includes insight data representing at least one cause for a given anomaly; and
registering the machine learning model with the model metadata in a model registry database.

16. The computer-implemented method of claim 15, wherein deploying the set of machine learning models comprises:
periodically generating a model inference request;
retrieving the set of machine learning models from the model registry database based on the model inference request;
retrieving a plurality of anomaly metrics for the set of machine learning models from a metric database based on the model inference request;
inserting the set of machine learning models and the plurality of anomaly metrics into a distributed model cache;
generating predicted signals based on the set of machine learning models in the distributed model cache;
determining prediction scores based on the predicted signals and actual signals corresponding to the predicted signals;
detecting the anomaly based on the prediction scores and the plurality of anomaly metrics; and
providing, via the first interface, a visualization of the actual signals, the predicted signals and the anomaly.

17. A non-transitory computer readable medium having instructions stored thereon, wherein the instructions, when executed by at least one processor, cause at least one device to perform operations comprising:
receiving a set of inputs via a first interface;
generating a set of machine learning models in response to the set of inputs;
deploying the set of machine learning models to detect an anomaly;
receiving feedback indicating a drift of at least one machine learning model in the set of machine learning models; and
re-training the at least one machine learning model to correct the drift.

18. The non-transitory computer readable medium of claim 17, wherein the operations further comprise:
generating an anomaly alert upon a detection of the anomaly associated with a corresponding application;
sending a message carrying the anomaly alert to a user of the corresponding application;
determining at least one system health metric degraded by the anomaly; and
automatically performing one or more remediation actions in real time to mitigate the anomaly regarding the at least one system health metric.

19. The non-transitory computer readable medium of claim 17, wherein re-training the at least one machine learning model comprises:
verifying the drift based on: (1) a deviation of a statistical distribution of signal data compared to training data of the at least one machine learning model, and (2) a frequency of anomaly detection by the at least one machine learning model; and
in accordance with a verification of the drift,
providing a first visualization of the at least one machine learning model before re-training the at least one machine learning model,
automatically re-training the at least one machine learning model by refining at least one hyperparameter of the at least one machine learning model based on the feedback and the verification of the drift, and
providing a second visualization of the at least one machine learning model after re-training the at least one machine learning model.

20. The non-transitory computer readable medium of claim 17, wherein each machine learning model in the set of machine learning models is generated based at least in part by:
retrieving historical data and configuration data from a model database based on the set of inputs;
generating a signal dataset based on the historical data and the configuration data;
generating a temporary version of the machine learning model based on a subset of the signal dataset;
providing, via the first interface to a user, a preview of an anomaly detection performance of the temporary version of the machine learning model; and
training the machine learning model based on the signal dataset in accordance with a determination that the user is satisfied with the preview of the anomaly detection performance.
